(19) United States
(12) Patent Application Publication
(10) Pub. No.: US 2005/0241595 A1
(43) Pub. Date: Nov. 3, 2005

(54) Self-propelled pet toy

(76) Inventor: Reynolds E. Moulton III, New York, NY (US)

Correspondence Address: David J. Rikkers, Esq.;Brown Rudnick Berlack Israels LLP, One Financial Center, Boston, MA, 02111, US

(21) Appl. No.: 10/772,073

(22) Filed: Feb. 4, 2004

Related U.S. Application Data
(60) Provisional application No. 60/444,782, filed on Feb. 4, 2003.

(51) Int. Cl. A01K 29/00

(52) U.S. Cl. 119/711

(57) ABSTRACT

A self-propelled pet toy is configured to include an attract, such as, for example, catnip. The pet toy is provided with a drive unit that may store energy for later release thereby providing movement to the pet toy and amusement to the pet. The self-propelled pet toy may be configured to look like an animal, such as a mouse, by its shape and also by the optional use of an outer layer of synthetic fur, facial components and/or a tail.

### REFERENCE TO RELATED APPLICATIONS

This application claims priority to U.S. Provisional Application No. 60/444,782, filed Feb. 4, 2003 and entitled “Toy for Cat Using Pull-Back Chassis and Embedded Catnip.” The contents of the provisional application are also incorporated herein by reference.

### TECHNICAL FIELD

The present invention relates to a mobile toy having an attractant for use with a pet.

### BACKGROUND

Pets have often played with small toys, often batting them around and/or chewing on them. In order to enhance the experience for pets, an attractant may be incorporated into the toy. For example, toys that are intended for use with cats may incorporate catnip to attract the cat and provide additional stimulation for the cat.

Catnip is a perennial herb belonging to the mint family Labiatae. Catnip is known in scientific nomenclature as “Napeta cateria.” The plant is a weed-like mint that is now native in North America and Canada after being introduced from the Mediterranean. The active ingredient in catnip is called nepetalactone. The response to this chemical is mediated through the olfactory system (vomeronasal organ) for which cats have a special receptor. Napetalactone induces a harmless, exciting, physiological reaction in some cats. This reaction has been studied in the art extensively, and has been found to induce a psychosexual response in both male and female cats.

However, the small toy that the pet is interacting with typically only moves upon being batted about by the pet during play. A need exists in the art to enhance the experience for pets when interacting with small toys and/or attractants, such as catnip.

### SUMMARY

The present invention is intended to enhance a pet's playtime experience by providing a self-propelled pet toy that is configured to include an attract. The self-propelled pet toy is provided with a drive unit that may store energy for later release thereby providing movement to the pet toy and amusement to the pet. The self-propelled pet toy may be configured to look like an animal, such as a mouse.

According to an illustrative embodiment of the invention, a pet toy is provided having a housing with a pet attractant coupled to the housing. A drive unit is also coupled to the housing and is capable of moving the housing.

According to further embodiment of the invention, a pet toy is provided having a drive unit coupled to a chassis. The drive unit is capable of moving the chassis. A storage unit is also coupled to the chassis, and an attractant is located in the storage unit. The attractant, such as catnip, is designed to attract the pet.

A further embodiment of the invention is a method of providing a pet toy. The method includes a step of providing a mobile housing having a drive unit and locating a pet attractant within the housing. The method may have an option to include further steps of providing energy to the drive unit and releasing the pet toy direct the energy through at least one wheel to propel the pet toy.

### BRIEF DESCRIPTION OF THE DRAWINGS

The invention will be apparent from the description herein and the accompanying drawings, in which like reference characters refer to the same parts throughout the different views.

FIG. 1 is an illustration of a pet toy according to an illustrative embodiment of the invention;

FIG. 2 is an illustration of a pet toy according to a further embodiment of the invention;

FIG. 3 is a front view of the pet toy of FIG. 1; and

FIG. 4 depicts a method according to a further embodiment of the invention.

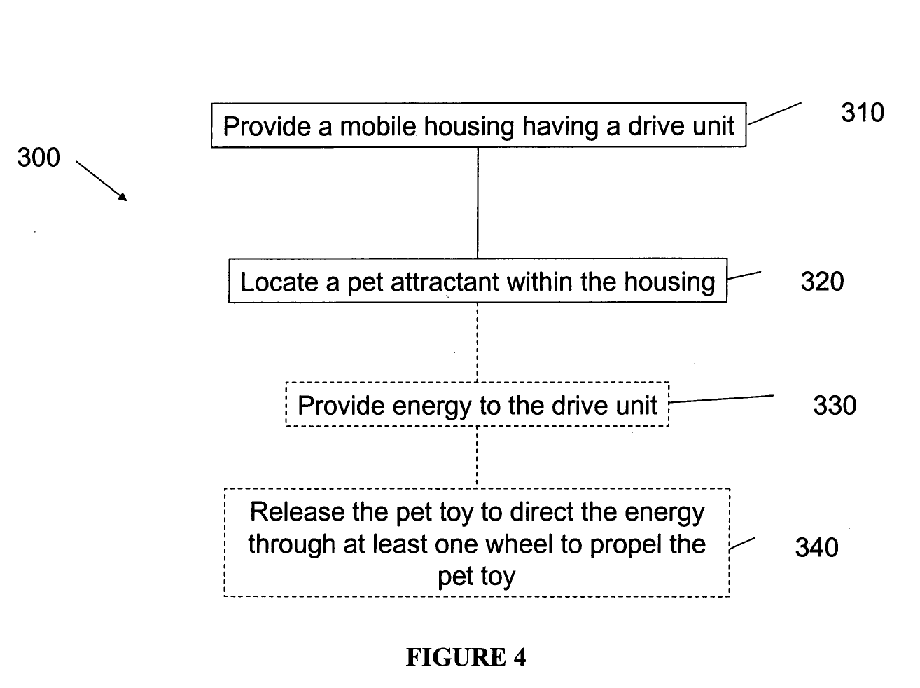

### DETAILED DESCRIPTION

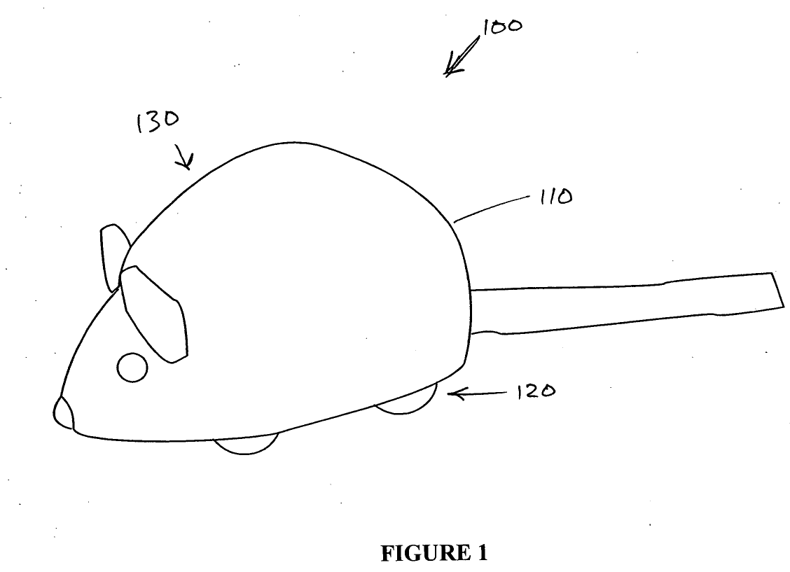

FIG. 1 illustrates an example of a pet toy 100 according to an embodiment of the invention. The pet toy 100 has a housing 110 configured in the shape of an animal. A drive unit 120 is located within the housing and is capable of moving the housing. The pet attractant 130, such as catnip, is also located within the housing 110.

The housing 110 may be formed of plastic, metal, wood or other similar materials. The housing 110 may be assembled in a variety of ways, such as by forming two portions to enable access to an interior of the housing 110 to enable locating the drive unit 120 and pet attractant 130 in the housing 110. The portions may then be mated together with an adhesive or fastening device, such as a screw. In this example, the portions may be left/right, top/bottom or front/back. The housing 110 may be configured to be separable and reattachable by the user, to allow for replacement of the attractant. For example a replaceable fastener, such as a screw, may be used to attach housing components.

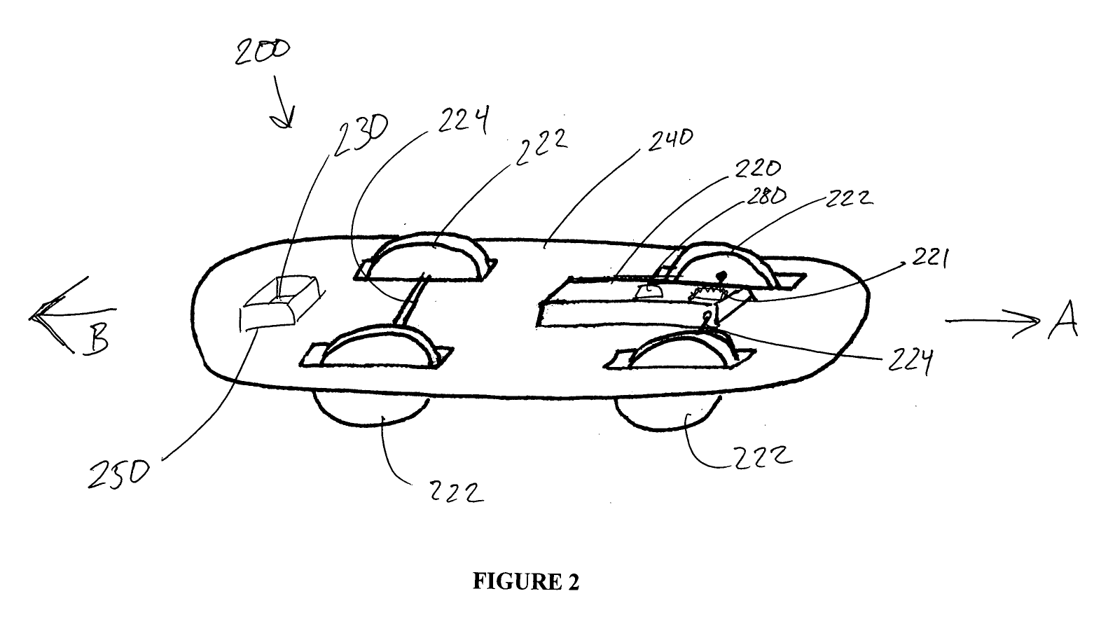

FIG. 2 illustrates a further embodiment of a pet toy 200. The pet toy 200 of FIG. 2 made be incorporated within the pet toy 100 of FIG. 1. The pet toy 200 includes a chassis 240 and a drive unit 220. The drive unit may include wheels 222 and axles 224, along with an energy storage device. The axles 224 maybe attached to chassis 240 in a variety of ways, such as clips, screws, adhesives or other means apparent others skilled in the art. The energy storage device of the drive unit 220 may involve one or more gears 221 coupled to a biased member, such as a spring. After storing energy in the drive unit 200 and upon release of the pet toy 200 to provide rotation of one or more wheels 222, thereby propelling the pet toy 200. By way of examples, the wheel 222 may be rotated by rotation of an axle 224 or may be driven directly by a gear operating on the wheel 222.

According to the illustrative embodiment of FIG. 2, an attractant 230, such as catnip, is intended to attract the pet to the pet toy 200. A storage unit 250 is coupled to the chassis 240 to provide for storage of the attractant 230. The storage unit 250 may be a box, as illustrated, a bag or other container, or may be a device to simply couple the attractant 230 to the chassis 240. Examples of such devices could include adhesive, a fastener, such as a staple, a screw, nail or band. An attractant 230 may be located within the storage unit 250. As used herein, the phrase, “located in the storage unit” is intended to include examples in which the attractant is coupled to the storage unit, even if only a portion of the attractant may physically be in a container, under a fastener or in contact with an adhesive.

The drive unit 220 may be formed of a wide variety of energy storage devices. Examples of drive units include, but are not limited to, spring drives similar to those shown in U.S. Pat. No. 3,961,440 to Saito, U.S. Pat. No. 3,981,098 to Darda, U.S. Pat. No. 4,077,156 to Asano, U.S. Pat. No. 4,241,534 to Larsson et al., U.S. Pat. No. 4,469,197 to Minoru, U.S. Pat. No. 4,493,671 to Kennedy et al. and U.S. Pat. No. 4,568,308 to Itoh.

In the example of the drive unit 220 being a full-back spring drive, the drive unit may be provided with energy by moving the drive unit 220 in a direction opposite from the direction of travel of the pet toy 200. For example, a user may move the pet toy 200 in direction A as shown in FIG. 2, thereby rotating wheels 222 rearward. Upon release of the pet toy 200, the energy stored in the drive unit 220 will be transmitted through one or more axles 220 to one or more wheels 222, causing the pet toy 200 to be propelled in direction B.

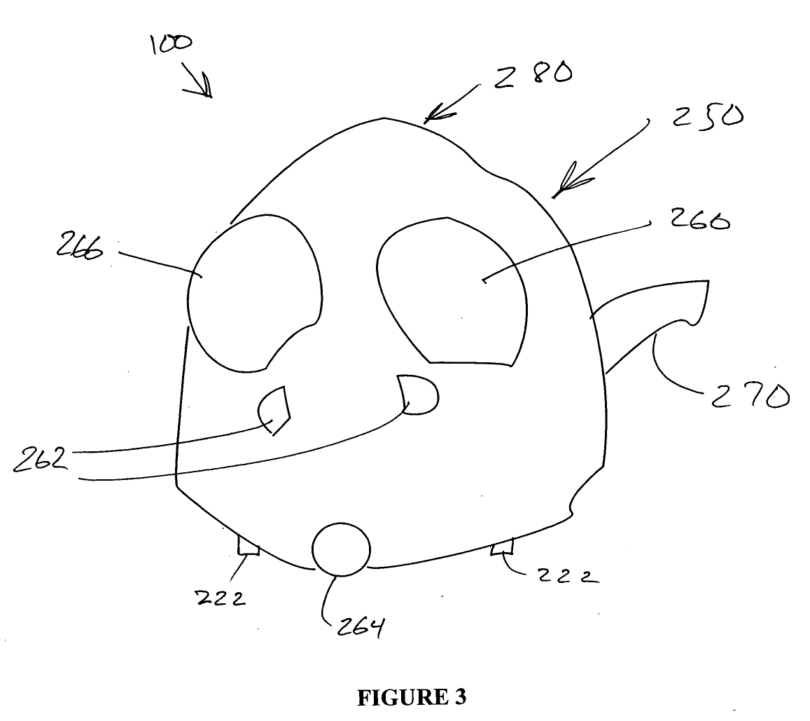

The pet toy 200 of FIG. 2 may also be configured with a housing 110, as illustrated by way of example in FIGS. 1 and 3. In this configuration, the storage unit 250 may optionally include anywhere within, or throughout, an interior of the housing 110. For example, the attractant 230 could be loose within the housing or affixed to the housing by an adhesive, a staple or other fastener. The housing 110 and chassis 240 may be configured to be separable and reattachable by the user, to allow for replacement of the attractant. In one example a screw is used to attach the housing 110 to the chassis 240.

Ballast 280 may optionally be provided to increase weight over the drive unit 220. Examples of ballast 280 include a nut or other device that could be secured to any component of the pet toy to provide weight. If a housing 110 is provided, the ballast 280 may be coupled to the chassis 240 by way of the housing 110.

As illustrated in FIG. 3, the housing 110 may be provided with additional components to enhance the appearance of the housing 110. For example, facial components, such as eyes 262, a nose 264 and ears 266 may be provided. Similarly, a tail 270 may be mounted to the pet toy. An outer layer 250 may also be provided on the housing 110. The outer layer 250 may be formed of a synthetic fur, cloth or other material to simulate the appearance of an animal.

According to a further embodiment of the invention, a pet toy is provided according to a method 300. The method 300 includes the step of providing 310a mobile housing having a drive unit. Also, the pet attractant is located 320 within the housing. Optionally, the method may further include the step of providing 330 energy to the drive unit. Also, the optional step of releasing, step 340 the pet toy to direct the energy through at least one wheel to propel the pet toy may be included.

The present invention has been described by way of example, and modifications and variations of the exemplary embodiments will suggest themselves to skilled artisans in this field without departing from the spirit of the invention. The examples included herein are meant to be illustrative and not limiting. Features and characteristics of the above-described embodiments may be used in combination. The preferred embodiments are merely illustrative and should not be considered restrictive in any way. The scope of the invention is to be measured by the appended claims, rather than the preceding description, and all variations and equivalents that fall within the range of the claims are intended to be embraced therein.

1. A pet toy, comprising:
a housing;
a drive unit coupled to the housing and adapted to move the housing; and
a pet attractant coupled to the housing.

2. The pet toy of claim 1, wherein the housing is configured in the shape of an animal.

3. The pet toy of claim 2, wherein the housing is configured in the shape of a mouse.

4. The pet toy of claim 1, wherein the attractant is catnip.

5. The pet toy of claim 1, wherein the drive unit is a pull-back spring drive.

6. The pet toy of claim 1, wherein the drive unit is provided with energy by moving the drive unit in a direction opposite from a first direction of travel of said chassis.

7. The pet toy of claim 6, wherein the energy is directed through at least one wheel, propelling the pet toy in the first direction.

8. The pet toy of claim 1, further comprising an outer layer, mounted on said housing, to provide a fur-like appearance.

9. The pet toy of claim 1, further comprising at least one facial component, mounted on a forward-facing portion of said housing.

10. The pet toy of claim 9, the at least one facial component including an eye, a nose and an ear.

11. The pet toy of claim 1, further comprising a tail, mounted to said housing and located on a rearward-facing portion of said housing.

12. The pet toy of claim 1, wherein the pet attractant is located in a storage unit coupled to the housing.

13. The pet toy of claim 1, wherein the pet attractant is located within the housing.

14. The pet toy of claim 1, wherein the pet attractant is located outside the housing.

15. A pet toy, comprising:
a chassis;
a drive unit coupled to the chassis for moving the chassis;
a storage unit coupled to the chassis; and
an attractant, located in the storage unit, configured to attract the pet.

16. The pet toy of claim 15, further comprising a housing coupled to the chassis, wherein the housing is configured in the shape of an animal.

17. The pet toy of claim 16, wherein the housing is configured in the shape of an animal.

18. The pet toy of claim 17, wherein the housing is configured in the shape of a mouse.

19. The pet toy of claim 16, further comprising an outer layer, mounted on said housing, to provide a fur-like appearance.

20. The pet toy of claim 16, further comprising at least one facial component, mounted on a forward-facing portion of said housing.

21. The pet toy of claim 20, the at least one facial component including an eye, a nose and an ear.

22. The pet toy of claim 16, further comprising a tail, mounted to said housing and located on a rearward-facing portion of said housing.

23. The pet toy of claim 16, wherein the pet attractant is located within the housing.

24. The pet toy of claim 1, wherein the pet attractant is located outside the housing.

25. The pet toy of claim 15, wherein the attractant is catnip.

26. The pet toy of claim 15, wherein the drive unit is a pull-back spring drive.

27. The pet toy of claim 15, wherein the drive unit is provided with energy by moving the drive unit in a direction opposite from a first direction of travel of said chassis.

28. The pet toy of claim 27, wherein the energy is directed through at least one wheel, propelling the pet toy in the first direction.

29. The pet toy of claim 15, further comprising a ballast, located over said drive unit.

30. The pet toy of claim 15 wherein the drive unit comprises at least one biased gear, an axle and a wheel, wherein the gear and axle are rotated by the biased gear.

31. The pet toy of claim 15, wherein the drive unit comprises a wheel.

32. A method of providing a pet toy, comprising the steps of:
providing a mobile housing having a drive unit; and
locating a pet attractant within the housing.

33. The method of claim 32, wherein the mobile housing in the step of providing is in the shape of an animal.

34. The method of claim 32, wherein the pet attractant in the step of locating is catnip.

35. The method of claim 32, further comprising the step of providing energy to the drive unit.

36. The method of claim 32, wherein the step of providing energy includes the step of moving the drive unit in a direction opposite from a first direction of travel of the mobile housing.

37. The method of claim 36, further comprising the step of releasing the pet toy to direct the energy through at least one wheel to propel the pet toy in the first direction.

38. A pet toy, comprising:
a housing configured in the shape of an animal; and
a drive unit coupled to the housing and adapted to move the housing, the drive unit configured to be provided with energy by moving the drive unit in a direction opposite from a first direction of travel of the housing.

39. The pet toy of claim 38, wherein the drive unit is provided with energy directed through at least one wheel, the drive unit configured to propel the pet toy in the first direction by turning the at least one wheel.

40. The pet toy of claim 39, wherein the housing is configured in the shape of a mouse.

41. The pet toy of claim 39, further comprising a tail, mounted to said housing and located on a rearward-facing portion of said housing.

42. The pet toy of claim 38, wherein the drive unit is a pull-back spring drive.

43. A pet toy, comprising:
a chassis;
a drive unit coupled to the housing and adapted to move the chassis, the drive unit configured to be provided with energy by moving the drive unit in a direction opposite from a first direction of travel of said chassis; and
a housing coupled to the chassis, wherein the housing is configured in the shape of an animal.

44. The pet toy of claim 43, wherein the drive unit is a pull-back spring drive.

45. The pet toy of claim 43, wherein the energy is directed through at least one wheel, propelling the pet toy in the first direction.

46. The pet toy of claim 43, wherein the housing is configured in the shape of a mouse.

47. The pet toy of claim 46, further comprising a tail, mounted to said housing and located on a rearward-facing portion of said housing.
